(19) United States
(12) Patent Application Publication
(10) Pub. No.: US 2013/0060658 A1
(43) Pub. Date: Mar. 7, 2013

(54) Method and system for import and export trading

(71) Applicants: Hui QUAN, Beijing (CN); Qiong Zhu, Beijing (CN); Chao Shen, Beijing (CN); Shi Yao, Beijing (CN); Xiaoli Wang, Beijing (CN)

(72) Inventors: Hui QUAN, Beijing (CN); Qiong Zhu, Beijing (CN); Chao Shen, Beijing (CN); Shi Yao, Beijing (CN); Xiaoli Wang, Beijing (CN)

(73) Assignee: Beijing Ace of Trade Technology Co., Ltd.

(21) Appl. No.: 13/226,740

(22) Filed: Sep. 7, 2011

(51) Int. Cl. G06Q 30/06

(52) U.S. Cl. 705/26.25

(57) ABSTRACT

A method and system of import and export trading is provided. The system and method includes a selection module, an import duty confirmation module, a database, and a displaying module. The selection module is configured for choosing basic information of commodity from lists of property choices provided by a website and submitting the choice to a server. The import duty confirmation module is configured for confirming HS code and duty rate corresponding to the commodity according to the choice. The database is configured for storing information of commodities, HS codes and rate of import duties. The displaying module is configured for displaying commodities provided by sellers to buyers for choosing. The sellers and buyers are in different countries or regions, when a buyer chooses one commodity, the server will provide corresponding import duty to the buyer according to the quantity of commodities and the duty rate.

### BACKGROUND

1. Technical Field

The present disclosure relates to the area of electronic commerce over the Internet, and more particularly to method and system for conducting import and export trading.

2. Description of Related Art

In an international trade, when a buyer wants to import a commodity from abroad, he often needs to account for the total costs of the commodity and decides whether to import the commodity according to the total costs. Besides the cost of the commodity itself, there could be other costs associated with importing the commodity. Examples of the total costs include shipping, warehousing, insurance and, more importantly, the tariff for the commodity by an exporting country as well as by an importing country. Each country has its own tariff import or export tax schedules. Different commodities are imposed upon by different tariffs. A protective tariff is often used by a government to attempt to control trade between nations to protect and encourage their noncompetitive or undeveloped local industries, businesses, unions etc. giving them time to become competitive.

A traditional approach in determining the total costs for importing or exporting a commodity, among other procedures is to provide the details of commodity to the customs of both importing and exporting countries. After the internal examination conducted by a custom, a trader is then notified of the importing or exporting tariff including a harmonized system code (HS Code). HS code is a standardized multi-functional system to classify goods, universally applied by governments of all countries, international organizations and individuals in many other fields, such as domestic tax, trade policy, price control, quota control, budgeting, and economic research and analysis. Therefore HS Code becomes a universally recognized classification standard and economic language.

It typically takes time (hours or even days depending on the nature of the goods) to get an HS code for the commodity in trading, thus inherently increasing the costs in doing business across different countries. Thus there is a need for techniques that can facilitate trading via importing or exporting more efficiently.

### SUMMARY

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure.

The present disclosure may be implemented as a method, a system or a software product. According to one embodiment, the present disclosure is a method for cross-border trading, the method comprises: choosing information of commodity from a lists of property choices in a website provided by a server and submitting the choices of a seller to a server; confirming HS code and duty rate corresponding to the commodity according to the information of commodity; displaying commodities provided by sellers to buyers for choosing, wherein the sellers and buyers are in different countries or regions, when a buyer chooses one commodity, the server will provide corresponding import duty to the buyer according to the quantity of commodities and the duty rate.

According to another embodiment, the present disclosure is a system for cross-border trading, the system comprises: a selection module configured for choosing basic information of commodity from lists of property choices provided by a website and submitting the choice to a server; an import duty confirmation module configured for confirming HS code and duty rate corresponding to the commodity according to the choice, the import duty confirmation is set in a serve; a database configured for storing information of commodities, HS codes and rate of import duties corresponding to the HS codes; and a displaying module configured for displaying commodities provided by sellers to buyers for choosing, wherein the sellers and buyers are in different countries or regions, when a buyer chooses one commodity, the server will provide corresponding import duty to the buyer according to the quantity of commodities and the duty rate.

Other advantages and novel features of the present disclosure will become more apparent from the following detailed description of preferred embodiment when taken in conjunction with the accompanying drawings.

### BRIEF DESCRIPTION OF THE DRAWINGS

These and other features, aspects, and advantages of the present disclosure will become better understood with regard to the following description, appended claims, and accompanying drawings where:

FIG. 1 shows a schematic configuration or application environment of conducting an import or export trading in accordance with a preferred embodiment;

FIG. 2 shows a functional block diagram of a server module to facilitate import and export trading between buyers and sellers;

FIG. 3 shows another functional block diagram of a server module to facilitate import and export trading between buyers and sellers;

FIG. 4 shows a flowchart or process of import or export trading of a first embodiment of the present disclosure;

FIG. 5 shows a flowchart or process of determining information of commodity in the first embodiment of FIG. 4;

FIG. 6 shows a flowchart or process for providing import or export trading (i.e., cross-border trading) between two parties presumably;

FIG. 7 shows a flowchart or process of import or export trading of a second embodiment of the present disclosure;

FIG. 8 shows an interface diagram of accounting transportation cost of the present disclosure;

FIG. 9 shows an interface diagram of accounting whole costs of the present disclosure;

FIG. 10 shows a flowchart or process of import or export trading of a third embodiment of the present disclosure.

### DETAILED DESCRIPTION

The detailed description of the invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth in order to provide a thorough understanding of the present disclosure. However, it will become obvious to those skilled in the art that the present disclosure may be practiced without these specific details. In other instances, well known methods, procedures, components, and circuitry have not been described in detail to avoid unnecessarily obscuring aspects of the present disclosure.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

In general, the word “module,” as used hereinafter, refers to logic embodied in hardware or firmware, or to a collection of software instructions, written in a programming language, such as, Java, C, or Assembly. One or more software instructions in the modules may be embedded in firmware. It will be appreciated that modules may comprise connected logic units, such as gates and flip-flops, and may comprise programmable units, such as programmable gate arrays.

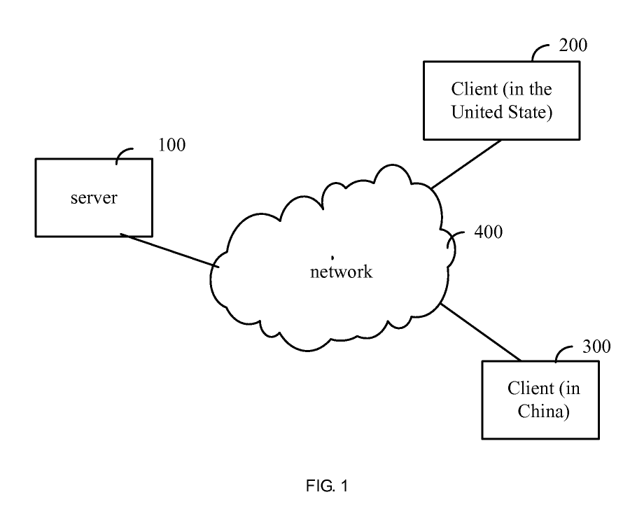

Referring now to the drawings, in which like numerals refer to like parts throughout the several views. FIG. 1 shows a schematic configuration or application environment of conducting an import or export trading in accordance with a preferred embodiment. The application environment includes a plurality of server machines and client machines (only one server computer 100 and two client computers are shown in FIG. 1 as an example). The client computer 200 is used by a buyer, and the other client computer 300 is used by a seller. The client computers 200, 300 are coupled to the server 100 via a network 400 that may be a wired network, a wireless network or a combination of wired and wireless network. An example of the client computer 200 or 300 may be a laptop computer, a desktop computer, a computing device (e.g.: smart phone and tablet).

Depending on implementation, the present disclosure may be implemented in various ways. For example, in one application, a server module implementing one embodiment of the present disclosure is loaded and executed in the server computer 100 to provide the desired results contemplated in the present disclosure when being accessed by a client machine. In another application, a client module implementing one part of an embodiment of the present disclosure is provided and downloaded to a client machine and configured to interact with a server machine to provide the desired results contemplated in the present disclosure.

According to one embodiment, the server 100 retains, collects or updates a list of commodities available for trading, HS codes and rate of import duties corresponding to the commodities among possibly other trading related information (e.g., shipping, warehousing or insurance). Depending on implementation, the server 100 may function as a portal or a repository. In one embodiment, the server 100 is coupled to different other servers providing necessary information to facilitate the trading across nations. For example, the server 100 may be coupled to a server managed by a government agency (e.g., a customs office) to receive updated tariff import or export tax schedules, the server 100 may be coupled to another government agency for information of any possible importing or exporting restrictions, the server 100 may also be coupled to other businesses providing warehousing, shipping and insurance rates and etc. In another embodiment, all information from related parties that may help in cross-border trading may be provided in different forms (e.g., in documents or electronic data), thus requiring the server 100 to be updated periodically or as needed depending on the nature of the information received.

When a buyer uses the client computer 200 to log into the server 100 via the network 400, the buyer is presented with a list of available commodities and chooses a commodity therefrom. After the buyer decides the commodity, the server 100 is configured to determine a corresponding HS code and rate of import duty, and other information if desired. The buyer can thus see, without much delay, the total costs of trading the commodity across the border, various other associated costs and rules/regulations, schedule or any warnings/advices if applicable.

In addition, a commodity may be offered by more than one seller. The buyer may see related information of the commodity by different sellers. For example, a seller sells one commodity cheaper than another seller does but imposes terms more complicated than the other seller. Accordingly, the buyer has accessed full information for each cross-border trading he is going to get into in almost real time.

According to another embodiment, the server 100 can be configured to store the information of commodities according to the choices of the commodities by the seller to facilitate a fast trading next time the buyer decides to trade similar commodities. In addition, the server 100 may be configured to continue updating the traded transactions to show any changes (e.g., cost or rules) to a particular commodity that the buyer has had. As a result, the buyer is updated of any trend in the commodity.

The embodiment shown in FIG. 1 shows that a buyer from in the United States while there are a number of sellers in China. The client computer 200 may be accessed by the buyer anywhere in the world. The client computer 300 is a representation of a seller in China hoping to export some commodities beyond China. The server 100 is configured to pull the information about the commodities as well as the seller and represent it with other information to the buyer.

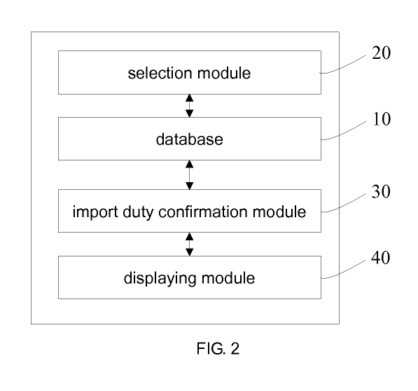

Referring to FIG. 2, it shows a functional block diagram of a server module to facilitate import and export trading between buyers and sellers. The functional block diagram includes a database 10, a selection module 20, an duty confirmation module 30, and a displaying module 40. Depending on implementation, the modules 20, 30, and 40 may be implemented in hardware, software or in combination of both hardware and software. According to one embodiment, the modules 20, 30, and 40 are implemented in software, stored in memory (e.g., a non-transitory readable medium) and executed by one or more processors to cause a server machine to perform desired operations in one embodiment of the present disclosure.

The server machine or server is coupled to a database 10 that is provided to store the information of the commodities available for trading. Depending on implementation and commodities available for trading, the information may include a list of the HS codes, the rate of import duties corresponding to the HS codes and other related data (e.g., shipping rate, warehousing rate, tax rate, and insurance rate). Some of the information about the commodities is defined or provided by a seller(s) and stored in the database of the server. In one embodiment, a seller uses a client computer to log in the server and uploads, manages or updates some of the information related to the commodities being put for trading by the seller.

The selection module 20 is set in a server and is provided to the sell to choose basic information of commodity from lists of property choices provided by the server and submit the choice of the seller to the server. The server displays the commodities information in an electronic commerce website to provide for the buyer to choose.

The duty confirmation module 30 is provided in the server to confirm a HS code and a duty rate corresponding to the selection provided by the selection module 20.

The displaying module 40 is configured in the server to display necessary information of the commodities available for trading to a buyer. In one embodiment, the displaying module 40 is configured to detect what tool or device the buyer is using and reformat the information for proper display with the tool or the device. For example, if a buyer uses a browser Chrome from Google, Inc., the displaying module 40 resets parameters for the browser and causes the content to be properly displayed in the browser. Likewise, if a buyer uses a smart phone (e.g., iPhone) to access the server, the displaying module 40 resets parameters for the access from the smart phone and causes the content to be properly displayed on the smart phone.

In general, the buyer and seller are in different countries or regions. When a buyer chooses one commodity, the server is configured to provide the corresponding costs including the import/export duty to the buyer according to the quantity of the commodities and the rate of the import or/and export duty.

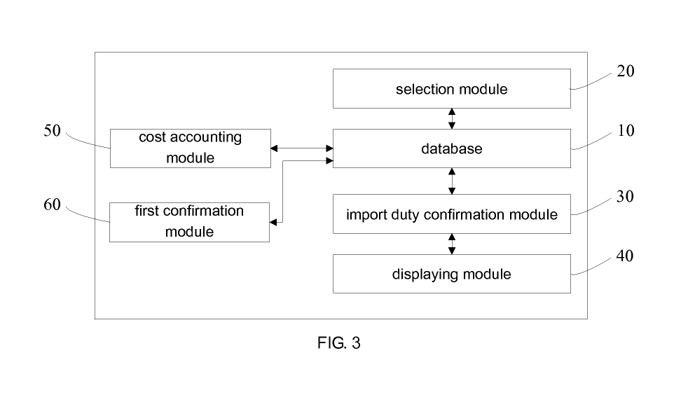

Referring to FIG. 3, it shows another functional block diagram of a server module to facilitate import and export trading between buyers and sellers. The server module includes a cost accounting module 50, and a confirmation module 60 besides those in FIG. 2. The cost accounting module 50 is provided to account for total transportation costs and times in different modes of transportations (e.g., via cargo and trailers) in accordance with the quantity and the commodity chosen by a buyer. According to one embodiment, the cost accounting module 50 is configured to get respective shipping costs automatically or manually (e.g., by manual input) from the transportation providers that may often update the shipping rate depending on the fuel costs and regions the shipping goes across.

The confirmation module 60 is configured to receive the payment of the buyer via a client computer and create a reminder to remind the seller when to get the chosen commodity ready. Although the payment may be made by paypal, a credit card transfer online, a cross-border trading is often involved in a large amount of money. In one embodiment, the confirmation module 60 is designed to accept a payment of letter of credit (LC) via uploading from a client computer being used by the buyer. Furthermore, the payment may also be made by telegraphic transfer.

In addition, the system further includes a settlement module (not shown). The settlement module is provided to receive a message from the confirmation module 60 before transferring the payment from the buyer to the seller (e.g., a designated account). In operation, the buyer is reminded to log into the server (i.e., the website) to submit a confirmation message meaning that the buyer has received the commodity. The seller will then submit a payment requisition to the server upon receiving the settlement message from the buyer or the server is configured to remind the seller when/where to settle the transaction. Once the seller responds, the server is configured to transfer the payment of the buyer to the designated account of the seller or authorize the settlement of the payment to the seller. In one perspective, the server functions as a trading platform to facilitate import or export trading in time and accuracy without having a seller and a buyer to meet physically. Depending on how the server is used to conduct a business, there may or may not be a charge for establish such an account. If there is a charge, such a charge may be a monthly or yearly fee or a transaction-based fee.

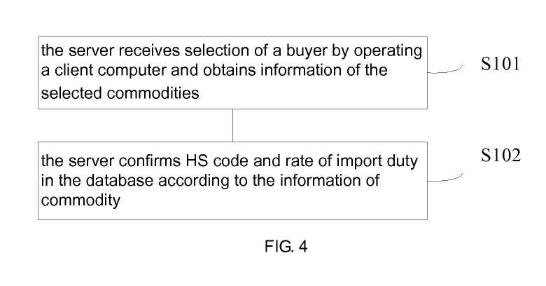

Referring to FIG. 4, a first embodiment of a method of import and export trading includes the steps of:

In step S101, the server receives selection of a buyer by operating a client computer and obtains information of the selected commodities.

The server has an electronic commerce website displaying the traded commodities to buyer for choosing. When a buyer log in the website by using a client, the website will record the selection of the buyer and will submit the selection to the server. The server has stored information of all commodities displayed in the website. The server also has stored HS codes and rate of import duties corresponding to the commodities. Therefore, the server can obtain the commodities information according to the selection of the buyer.

In addition, before the above step, the method further includes the step of storing commodities information in the server. The commodities information can be fixed by sellers of the commodities. For example, when a seller wants to sell his commodities through the system, he should describe his commodities first, so that the buyer can know about his commodities and choose required commodities according to the description. In order to ensure the unity of the description of the same commodities, the server will store commodities description and provide appropriate multiple-choice options for the seller to choose.

In step S102, the server confirms HS code and rate of import duty in the database according to the information of commodity.

The server confirms HS code stored in the database according to the information of commodities, then the server confirms the duty rate according to the HS code and displays the rate of import duty to the buyer in the website. Therefore, the buyer can obtain the import duty instantly and account cost of the chosen commodities.

Preferably, when some commodities are added to sell, the corresponding HS codes and rate of import duties should also be updated in the database of the server. In order to ensure that the cost calculation is accuracy, the HS code and rate of import duty can be obtained from the customs database directly. The database of the serve can be updated in real time or regularly (for example, updated daily). Of course, because the HS code does not change frequently, the database of the serve can also be updated by human.

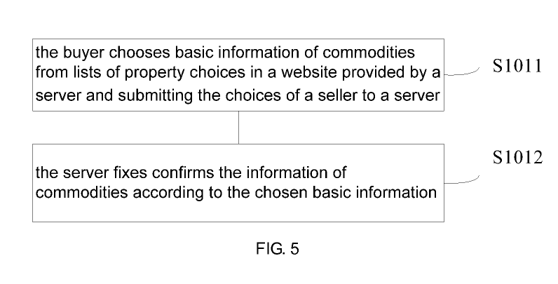

Referring to FIG. 5, the information of commodity determined process is as follows:

In step S1011, the buyer chooses basic information of commodities from lists of property choices in a website provided by a server and submitting the choices of a seller to a server.

The server has stored basic information of commodities, and provides many multiple-choice options in the website to the seller to choose. The seller can choose the option appropriate for the commodities as basic information.

In step S1012, the server confirms the information of commodities according to the chosen basic information.

After the seller had chosen each option of the basic information, the server will get commodities description by combining the chosen options and the stored information, then displays in the website. The seller will judge the commodities description whether is exact, if the commodities description is consistent with the commodities, the seller will submit a confirmation to the server, if the commodities description is not consistent with the commodities, the seller can choose basic information again, until the commodities description is consistent with the commodities.

When a buyer visit the website via a client and choose commodities, the server will automatically obtain the corresponding commodities information according to the selection of the buyer.

When the present disclosure is applied, for example, Chinese commodities enter in the United State market. That is, the seller is in China, the buyer is in the United States, and the United States customs duty is used. Each HS code of the United States customs has a detailed and complex description, to determine whether a commodity belongs to the HS code. However, the confirmation of the HS code is very complex and abstract, it is often needed experienced customs to complete. The present disclosure interprets and divides each HS code into a plurality of properties. Therefore, the seller can choose the best consistent property to the commodity one by one. After the seller has chosen all the properties appropriate for the commodity, the corresponding HS code can be confirmed. In this process, it is only needed the seller is familiar with the commodity, which is easy to meet. The buyer does not care about the HS code, he can choose the commodity what he needed, because that HS code of each commodity has been confirmed by the server according to the choices of the seller. When the buyer chooses a commodity, the server can display the corresponding rate of import duty in the website directly.

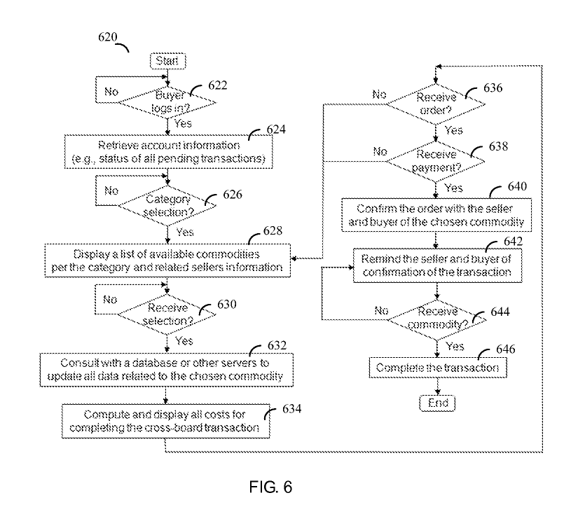

Referring to FIG. 6, it shows a flowchart or process 620 for providing import and/or export trading (i.e., cross-border trading) between two parties presumably in or represent two different countries. FIG. 1-FIG. 5 may be referred to facilitate the description of the process 620 but may be implemented without the limitations in the embodiments shown in FIG. 1-FIG. 5. The process 620 may be implemented in software or a combination of software and hardware. The following description of the process 620 is based on one embodiment in which a server module implementing the embodiment is executed in a server, a website of the server is provided to be interacted with a buyer. Those skilled in the art shall readily understand the operations of other embodiments in which setting or configuration may be different from what is described herein. For example, the interactions between the server and a smart phone (with an installed client module implementing one embodiment) would be slightly different from the interactions between a buyer and a website, but all principles are substantially similar without departing from the present disclosure.

The process 620 starts at 622 where a buyer logins into a website of a server (e.g., the server 100 of FIG. 1). The buyer may access the website using a specific internet browser (e.g., Internet Explorer from Microsoft or Chrome from Google) or a portable device (e.g., smart phone). Usually, the buyer has already established an account with the website and provided his own preference in the account. The preference may include but not be limited to his residence country (e.g., Canada), preferred currency (e.g., US$) to settle a trade, his contact information, his common commodity category (e.g., warehouse machinery), his preferred import port in his country and his preferred transportation partners. Likewise, each of sellers and trading partners using the website for their trading or service may also have one or more accounts in which each of the accountholders has his or its own setting with preferred data similar to that of the buyer with other information fitting its own purpose.

After the buyer successfully logs into the website (e.g., an electronic cross-border trading platform), some or all of the account information is retrieved for the buyer at 624 to facilitate a possible trading in time for the buyer without requiring many interactions from the buyer or delay. Should the buyer have a pending transaction that has not been closed, the website can also display such a pending transaction to alert the buyer what actions may need to follow. For example, the buyer has ordered a load of electronic tools from a seller, where only a portion of the shipment has been shipped out the by the seller. Thus the buyer may make an inquiry of the remaining shipment to the seller. In another example, the buyer may be alerted that the seller has not received the full payment to the order made by the buyer. Thus the buyer may follow up with the inquiry from the seller to close the transaction as soon as possible.

At 626, the website displays a list of categories for the buyer to choose. Instead of showing all commodities, the server is configured to organize the available commodities in categories. In one embodiment, the available commodities are organized according to the HS codes. In operation, the buyer may select one or more categories or a category the buyer used to browse or order is automatically retrieved. In one embodiment, the account of the buyer in the server is configured to monitor or analyze the interest of the buyer to make it easy for the buyer to decide a selection from hundreds perhaps thousands of goods available to buy. In any case, the website displays a list of commodities per the category and related sellers information at 628. Other ways of showing the available commodities are possible.

At 630, the server is configured to determine if the selection has been made by the buyer or such a selection is valid. For example, sometimes a buyer did not make a proper selection but proceed to submit an order of a commodity. If the check fails, the process 620 returns. Once the check is confirmed, the process proceeds to 632, where the server is configured to gather all the information or data that may affect the transaction. Examples that may affect the transaction include a restriction placed by a government to prohibit the shipment of the chosen commodity to a designated country, the corresponding HS code, the updated import or export duty of the chosen commodity (per the HS code), transportation means, shipping conditions of the particular commodity, insurance or warehousing cost. Depending on implementation, one or more of the exemplary data affecting the transaction may be used with other data (e.g., shipping schedule and delivery time).

In any case, all the costs are computed and displayed at 634 to the buyer with options to choose, especially, the shipping means and their schedules. At 636, the server awaits the order from the buyer. The buyer may make his mind as to what quality of the commodity to order, what shipping means to use and what time, and etc. Once the buyer has assembled the order, the order may be submitted to the server at 636. If no order is made, the process 620 goes back to 628 to continue displaying the list or other lists of commodities for the buyer to choose from.

It is assumed that the user has assembled the order at 638. The order is then received at the server. The server is configured to confirm the order with the seller and buyer of the ordered commodity at 640. For example, among many items to confirm, the server may check the inventory updated by the seller if there is enough quantity to satisfy the order by the buyer or if any of conditions placed by the buyer may be met. It is assumed again that the order is good, meaning the buyer is willing to pay for the total costs and take reasonable efforts to follow up with an instruction to pay for the costs in a specific currency and receive the delivery as specified. In one embodiment, the buyer pays for the order using a credit card or money transfer, in which case the server module may be implemented to include a payment module to facilitate such payment means. The details of such payment module are omitted herein as it is very well known to those skilled in the art.

In one embodiment, the order at 640 has to be confirmed with different parties that may ultimately make the trading complete. Examples of the parties may include but not be limited to a government agency, a transportation provider, an insurance company, a warehouse and a loading/unloading crew. Although not all of them would be confirmed regarding an order commodity, at least one of them would be in one embodiment of the present disclosure.

According to one embodiment, the server module includes a payment module designed to allow the buyer to upload a letter of credit (LC) issued by a bank (e.g., by image or issuing number). The payment module is configured to verify such an LC with the bank to ensure that the LC is authenticated and authorized. At this point, it is assumed that the payment is received, the process 620 then stays pending for confirmation of the delivery or/and actual payment.

At 644, the buyer is reminded to confirm the delivery of the commodity. After the delivery is confirmed, and the payment is received, the transaction of the ordered commodity is considered complete at 646.

In one embodiment, when a new commodity is needed to update online and obtain the corresponding HS code, the following steps show how to choose the properties of the commodity to obtain the right HS code.

The first step of choice:

[symbol] footwear (except asbestos material)

□ Orthopedic footwear or other orthopedic appliances

□ Toy footwear

□ Skating boots with ice or roller skate attached

The second step of choice:

□ Waterproof Footwear with outer soles and uppers of rubber or plastics, the uppers of which are neither fixed to the sole nor assembled by stitching, riveting, nailing, screwing, plugging or similar processes

□ Other Footwear with outer soles and uppers of rubber or plastics

□ Footwear with outer soles of rubber, plastics, leather or composition leather and uppers of leather

[symbol] Footwear with outer soles of rubber, plastics, leather or composition leather and uppers of textile materials

□ Other footwear

□ Parts of footwear (including uppers whether or not attached to soles other than outer soles); removable insoles, heel cushions and similar articles; gaiters, leggings and similar articles, and parts thereof.

The third step of choice:

[symbol] Footwear with outer soles of rubber or plastics

□ Footwear with outer soles of leather or composition leather

The forth step of choice:

□ Sports footwear; tennis shoes, basketball shoes, gym shoes, training shoes and the like

[symbol] Other

The fifth step of choice:

□ Footwear having uppers of which over 50 percent of the external surface area (including any leather accessories or reinforcements such as those mentioned in note 4(a) to this chapter) is leather

□ Footwear designed to be worn over, or in lieu of, other footwear as a protection against water, oil, grease or chemicals or cold or inclement weather

[symbol] Footwear with open toes or open heels; footwear of the slip-on type, that is held to the foot without the use of laces or buckles or other fasteners, the foregoing except footwear of subheading 6404.19.20 and except footwear having a foxing or foxing-like band wholly or almost wholly of rubber or plastics applied or molded at the sole and overlapping the upper

□ Other

The sixth step of choice:

[symbol] Less than 10 percent by weight of rubber or plastics

□ Other

The seventh step of choice:

[symbol] with uppers of vegetable fibers

□ Other

The eighth step of choice:

□ House slippers

[symbol] Other

The ninth step of choice:

□ for men

[symbol] for women

□ Other

The last properties of the commodity is as follows: Footwear with outer soles of rubber/plastic, and upper of vegetable fibers, not elsewhere specified or included, with open toes/heels or slip-on type, less than 10% rubber/plastics by weight, and for women. The corresponding HS code can be confirmed according to the above chosen properties, although the HS code and the corresponding rate of import duty may not be necessarily displayed.

As described above, the commodities may be organized in categories with properties according to the HS codes. However, each property is multiple-choice. Thus the combination of different choices of each property can obtain different HS codes. The kinds of properties can be decided according to the specific industries. For example, in the above embodiment, in a footwear industry, exemplary properties include category property, materials property, style property, material content property, men's or women's property, and so on.

The seller marks the best description from a list of choices step-by-step of each property and eventually obtains a detail description for the commodity. The server may be configured to confirm an import duty for the commodity simultaneously with the rate of import duty being hidden in the server instead of being displayed in the website. When a buyer chooses a commodity through the website, the hidden rate of import duty can be used to account for the import duty of the commodity.

One aspect of the present disclosure is to provide a means for a seller to classify his goods into a right HS code. In one embodiment, a seller is provided a mechanism with respect to the general classified rules of the HS code, the directories of notes, and the directories of import-export duty, all of which are classified into a list of choices for the seller to choose. Thus a seller does not have to fully understand the inherently complicated HS codes. If the seller chooses the right properties, the corresponding HS code can be confirmed exactly, which decreases the accounting cost of the customs duty and facilitates the order process by a potential buyer.

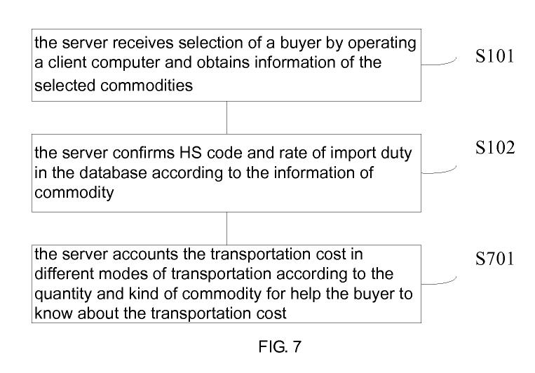

Referring to FIG. 7, a second embodiment of a method of import and export trading is shown. The different between the first and second embodiments is that the second embodiment further includes the following step after the step S102 of the first embodiment:

In step S701, the server accounts the transportation cost in different modes of transportation according to the quantity and kind of commodity for help the buyer to know about the transportation cost.

The server includes a transportation cost accounting system, when a buyer chooses the quantity of the commodity and the mode of transportation, the server will automatically account the corresponding transportation cost and display the result in the website for the buyer to choose. For example, the transportation modes may includes TDA (Trade Direct by Air), TDO (Trade Direct by Ocean), and EP (Trade Direct by Express Parcel). The buyers can combine each kind of transportation time and price to determine to choose one transportation mode.

Fox example, the door to door cost of TDA is accounted as follow:

TDA=[FOB price]+[consolidation cost]+[import tax]

The factors of the accounting includes price of commodity, exchange rate of the US dollar, insurance, domestic freight, inspection fee, air freight, label fee, and so on.

The door to door cost of TDO is accounted as follow:

TDO=[FOB price]+[consolidation cost]+[import tax]

The factors of the accounting includes price of commodity, exchange rate of the US dollar, ocean freight, insurance fee, domestic freight, inspection fee, export fee, label fee, and so on.

The door to door cost of EP—Express Parcel is accounted as follow:

EP=[Product cost]+[consolidation cost]

The factors of the accounting includes price of commodity, exchange rate of the US dollar, parcel fee, and so on.

In addition, the transportation cost may be different according to the different commodities or different quantities of commodity. Furthermore, the server will account the expected arriving time at the same time, because the expected arriving time may be different not only according to the different modes of transportation, but according to the transportation fee.

In conclusion, the present disclosure as above described can add all kinds of costs created in a commerce to account the whole costs, therefore, the buyer can clear about the whole costs in the commerce and choose the appropriate transportation mode according to the time and costs.

In addition, in one transportation, when the commodities chosen by a buyer are in different regions and are belongs to different sellers, the buyer only pays for all the commodities with a total price instead of paying for them to the different sellers one by one. Therefore, the costs of the commodities can be reduced.

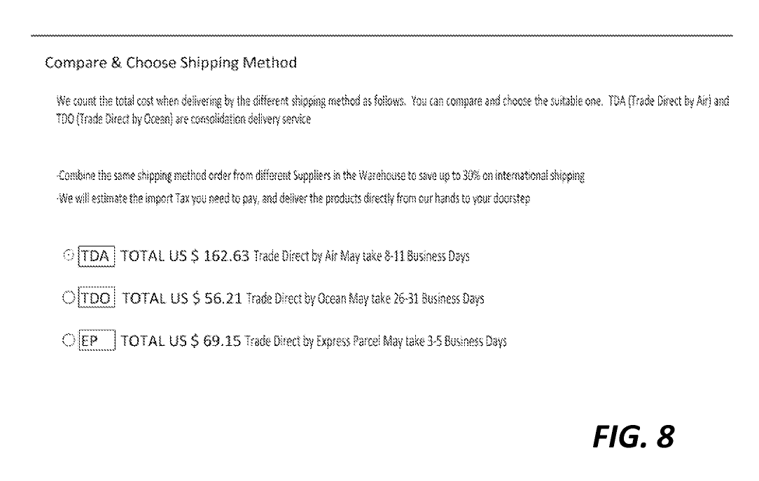

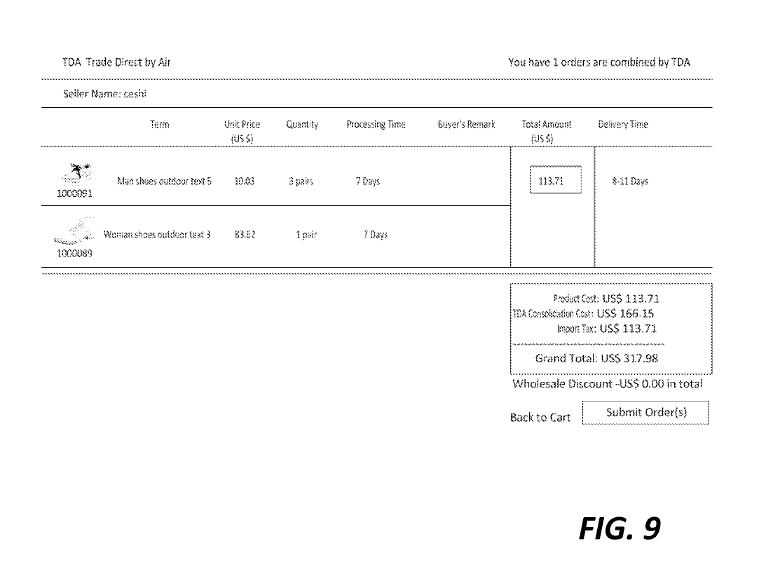

Referring to FIG. 8 and FIG. 9, FIG. 8 shows an interface diagram of accounting transportation cost, and FIG. 9 shows an interface diagram of accounting whole costs. The logistic time and costs shown in the FIG. 8 and FIG. 9 are only an embodiment of the present disclosure, in an actual transportation, the logistics time and costs are different according to the different commodities.

Preferably, the server also stores different price lists of different logistic companies, including different logistic company import and export links and the prices of different products, for example, in one mode of transportation, different logistic companies may have different prices to the same kind and quantity of commodities. Then the buyer can compare prices to choose one logistic company to transport his commodities. Each logistic company can upload its transportation prices into the server daily. Preferably, the logistic companies can also update the prices timely to make sure the prices are exact enough.

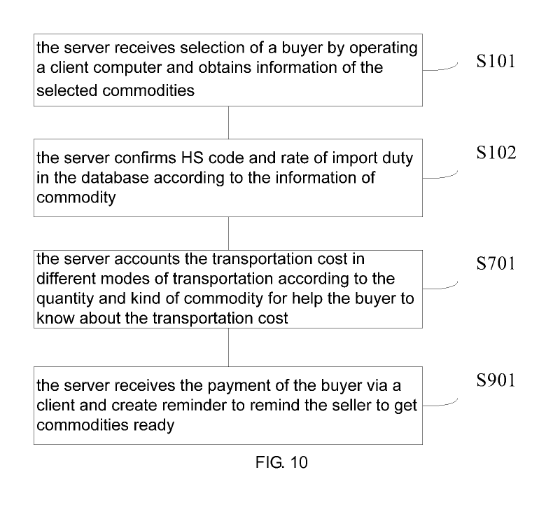

Referring to FIG. 10, a third embodiment of a method of import and export trading is shown. The different between the second and third embodiments is that the third embodiment further includes the following step after the step S701 of the second embodiment.

In step S901, the server receives the payment of the buyer via a client and create reminder to remind the seller to get commodities ready.

The server can associate with one payment platform, when the buyer has achieved payment of the chosen commodities, the server will transmit the payment data to the payment platform. The payment platform will check out the buyer whether has achieved payment and transmit the checked result to the server. If the payment is checked, the server will create a reminder to remind the seller to get the commodities ready.

Of course, the server can also be integrated into one payment platform itself to complete the payment process.

Preferably, when the buyer has received the commodities, he should log in the website to send a confirmation message via the client to confirm that he has received the commodities. The seller will also should log in the website to send a payment requisition. When the server receives the confirmation message from the buyer and the payment requisition from the seller, it will transfer the payment of the buyer to the seller.

In addition, the buyer may forget to confirm in the website, therefore, the server can set a default time, when the default time is up, the buyer had not confirm in the website, and did not have any other problems, the server can transfer the payment of the buyer to the seller only according to the payment requisition from the seller, without considering the confirmation message from the buyer, which can balance the benefits of the buyer and the seller.

An electronic commerce process used the above described embodiments includes the steps of:

In step S1, the seller displays his commodity on an electronic commerce website, and fixes the detail description of his commodity by choosing information of the commodity form a lists of property choices provided by the server corresponding to electronic commerce website and submitting the choices to the server.

In step S2, the server corresponding to the electronic commerce website confirms the HS code and rate of import duty corresponding to the commodity according to the information of commodity.

In step S3, when a buyer logs in the electronic commerce website, he can browse the information of commodities and obtain of the import duty, and the buyer can choose required commodities and the quantity of the commodities according to the information of commodities and the import duty.

In step S4, the server corresponding to the electronic commerce website accounts three kinds of transportation costs and times corresponding to the TDA, TDO, EP respectively.

In step S5, the buyer confirms the mode of transportation, the transportation cost, the price of the commodities, and the import duty, then pays for the commodities to the account of the electronic commerce website or the payment platform.

In step S6, the server reminds the seller to get the commodities ready and send the commodities to a logistic company.

In step S7, the owner of the server will do the import-export inspection for the commodities, and the logistic company will do the import-export customs procedures for the commodities and integrate all commodities to send them the specific buyer.

In step S8, when the buyer has received the commodities, he will confirm on the electronic commerce website.

In step S9, when the server received the payment requisition from the seller, the server will transfer the payment of the buyer to the seller to achieve the whole electronic commerce process.

In this process, the buyer and the seller only need to choose and confirm the commodities. The server will obtain the HS code and rate of import duty from the stored database and account the costs after the seller has confirmed the basic information of the commodities, then display them in the electronic commerce website. The buyer also can log in the website to obtain relevant information and account the costs of the imported commodities.

In addition, the present disclosure of system and method of import and export trading can also achieve unified port inspection and use the internet and database to achieve data sharing and tracking. The buyers and the sellers do not need to worry about the cumbersome import-export procedures and the international transportation.

We know that thousands of retailers in the United States market are selling commodities made in China. They once need to experience multiple channels to get commodities; however, they now get commodities from the Chinese sellers directly through the electronic commerce website. Therefore, there is no doubt that the costs of the buyers (retailers) can reduce obviously and the efficiency of purchasing can also be improved.

At the same time, the owner of the server is set as a third party guarantee, which ensures the interests both of the buyers and sellers and avoids the seller receiving payment without delivery, it also avoids the buyer receiving commodities with payment.

The present disclosure has been described in sufficient detail with a certain degree of particularity. It is understood to those skilled in the art that the present disclosure of embodiments has been made by way of examples only and that numerous changes in the arrangement and combination of parts as well as steps may be resorted without departing from the spirit and scope of the invention as claimed. Accordingly, the scope of the present disclosure is defined by the appended claims rather than the forgoing description of embodiments.

What is claimed is:

1. A computer-based method for import and export trading, the method comprising:
choosing information of commodity from a lists of property choices in a website provided by a server and submitting the choices of a seller to a server;
confirming HS code and duty rate corresponding to the commodity according to the information of commodity;
displaying commodities provided by sellers to buyers for choosing, wherein the sellers and buyers are in different countries or regions, when a buyer chooses one commodity, the server will provide corresponding import duty to the buyer according to the quantity of commodities and the duty rate.

2. The method of claim 1, wherein the property choices includes different kinds of properties, each property is multiple-choice; the server confirms a HS code and a duty rate according to the choices of all kinds of properties.

3. The method of claim 2, wherein the kinds of property includes at least one of the materials property, style property, material content property, and men's or women's property.

4. The method of claim 1 further comprising the step of:
accounting door to door costs and times in different modes of transportation according to the quantity and kind of commodity of the buyer via a client.

5. The method of claim 4, wherein the mode of transportation is Trade Direct by Air, at least one of the price of commodity, exchange rate of the US dollar, insurance, domestic freight, inspection fee, air freight, and label fee is used to account door to door cost.

6. The method of claim 4, wherein the mode of transportation is Trade Direct by Ocean, at least one of the price of commodity, exchange rate of the US dollar, ocean freight, insurance fee, domestic freight, inspection fee, export fee, and label fee is used to account door to door cost.

7. The method of claim 4, wherein the mode of transportation is Trade Direct by Express Parcel, at least one of the price of commodity, exchange rate of the US dollar, and parcel fee is used to account door to door cost.

8. The method of claim 4 further comprising the step of:
receiving payment of the buyer and creating reminder to remind the seller to get commodities ready.

9. The method of claim 4 further comprising the step of:
transferring payment of the buyer to the seller after the buyer submitted a confirmation message and the seller submitted a payment requisition.

10. A system for import and export trading, comprising:
a selection module configured for choosing basic information of commodity from lists of property choices provided by a website and submitting the choice to a server;
an import duty confirmation module configured for confirming HS code and duty rate corresponding to the commodity according to the choice, the import duty confirmation is set in a serve;
a database configured for storing information of commodities, HS codes and rate of import duties corresponding to the HS codes; and
a displaying module configured for displaying commodities provided by sellers to buyers for choosing, wherein the sellers and buyers are in different countries or regions, when a buyer chooses one commodity, the server will provide corresponding import duty to the buyer according to the quantity of commodities and the duty rate.

11. The system of claim 10, wherein property choices includes different kinds of properties, each property is multiple-choice; the server confirms a HS code and a duty rate according to the choices of all kinds of properties.

12. The system of claim 11, wherein the kinds of property includes at least one of the materials property, style property, material content property, and men's or women's property.

13. The system of claim 10 further comprising a cost accounting module for accounting door to door costs and times in different modes of transportation according to the quantity and kind of commodity of the buyer via a client.

14. The system of claim 13, wherein the mode of transportation is Trade Direct by Air, at least one of the price of commodity, exchange rate of the US dollar, insurance, domestic freight, inspection fee, air freight, and label fee is used to account door to door cost.

15. The system of claim 13, wherein the mode of transportation is Trade Direct by Ocean, at least one of the price of commodity, exchange rate of the US dollar, ocean freight, insurance fee, domestic freight, inspection fee, export fee, and label fee is used to account door to door cost.

16. The system of claim 13, wherein the mode of transportation is Trade Direct by Express Parcel, at least one of the price of commodity, exchange rate of the US dollar, and parcel fee is used to account door to door cost.

17. The system of claim 13 further comprising a first confirmation module for receiving payment of the buyer and creating reminder to remind the seller to get commodities ready.

18. The system of claim 13 further comprising a second confirmation module for transferring payment of the buyer to the seller after the buyer submitted a confirmation message and the seller submitted a payment requisition.
